(19) United States
(12) Patent Application Publication
(10) Pub. No.: US 2024/0177920 A1
(43) Pub. Date: May 30, 2024

(54) COIL COMPONENT

(71) Applicant: SAMSUNG ELECTRO-MECHANICS CO., LTD., Suwon-si (KR)

(72) Inventors: Ye Ji JUNG, Suwon-si (KR); Jae Hun KIM, Suwon-si (KR); Ju Hwan YANG, Suwon-si (KR); Boum Seock KIM, Suwon-si (KR)

(73) Assignee: SAMSUNG ELECTRO-MECHANICS CO., LTD., Suwon-si (KR)

(21) Appl. No.: 18/386,348

(22) Filed: Nov. 2, 2023

(30) Foreign Application Priority Data
Nov. 30, 2022 (KR) 10-2022-0164923

(51) Int. Cl. H01F 27/28; H01F 27/00; H01F 27/29; H01F 27/32

(52) U.S. Cl. CPC H01F 27/2828; H01F 27/006; H01F 27/29; H01F 27/327

(57) ABSTRACT

A coil component includes: a body having a first surface and a second surface opposing each other; a support member disposed in the body, and having one surface and the other surface opposing each other; a coil including first and second coil portions disposed on the one surface and the other surface of the support member and having at least one turn, respectively, and a via connecting the first and second coil portions; and first and second external electrodes respectively disposed on the first and second surfaces of the body and connected to the coil, wherein the via includes an upper surface in contact with the first coil portion and a lower surface in contact with the second coil portion, and a ratio VD_{U}/VD_{L} of a diameter VD_{U} of the upper surface to a diameter VD_{L} of the lower surface is 1.06 or more and 1.64 or less.

### CROSS-REFERENCE TO RELATED APPLICATION (S)

This application claims benefit of priority to Korean Patent Application No. 10-2022-0164923 filed on Nov. 30, 2022 in the Korean Intellectual Property Office, the disclosure of which is incorporated herein by reference in its entirety.

### BACKGROUND

### 1. Technical Field

The present disclosure relates to a coil component.

### 2. Description of Related Art

An inductor, one of coil components, is a representative passive electronic component used in an electronic device together with a resistor and a capacitor.

As the electronic device becomes more sophisticated and miniaturized, the number of electronic components used in the electronic device is also increased and their sizes are miniaturized.

A coil component including a thin-film support member in the component for its miniaturization may require a via connecting coil portions disposed on the upper and lower surfaces of the support member to each other.

### SUMMARY

An aspect of the present disclosure may provide a coil component with lower void defects occurring in a via hole during a plating process when forming a via passing through the support member.

Another aspect of the present disclosure may implement a thin coil component by a support member made thin.

Another aspect of the present disclosure may increase production efficiency of the coil component by reducing process operations of forming a via hole.

According to an aspect of the present disclosure, a coil component may include: a body having a first surface and a second surface opposing each other in a first direction; a support member disposed in the body, and having one surface and the other surface opposing each other; a coil including first and second coil portions disposed on the one surface and the other surface of the support member and having at least one turn, respectively, and a via passing through the support member to connect the first and second coil portions to each other; and first and second external electrodes respectively disposed on the first and second surfaces of the body and connected to the coil, wherein the via includes an upper surface in contact with the first coil portion and a lower surface in contact with the second coil portion, and a ratio VD_{U}/VD_{L} of a diameter VD_{U} of the upper surface to a diameter VD_{L} of the lower surface is 1.06 or more and 1.64 or less.

According to an aspect of the present disclosure, a coil component may include: a body having a first surface and a second surface opposing each other in a first direction; a support member disposed in the body, and having one surface and the other surface opposing each other; a coil including first and second coil portions disposed on the one surface and the other surface of the support member and having at least one turn, respectively, and a via passing through the support member to connect the first and second coil portions to each other; and first and second external electrodes respectively disposed on the first and second surfaces of the body and connected to the coil, wherein the via includes an upper surface in contact with the first coil portion and a lower surface in contact with the second coil portion, a ratio VD_{U}/VD_{L} of a diameter VD_{U} of the upper surface to a diameter VD_{L} of the lower surface is 1.06 or more and 1.64 or less, and the diameter VD_{U} of the upper surface is greater than a line width of each of the at least one turn of the first and second coil portions.

### BRIEF DESCRIPTION OF DRAWINGS

The above and other aspects, features and advantages of the present disclosure will be more clearly understood from the following detailed description taken in conjunction with the accompanying drawings, in which:

FIG. 1 is a perspective view schematically illustrating a coil component according to a first exemplary embodiment of the present disclosure;

FIG. 2 is a view illustrating a cross-section taken along line I-I′ in FIG. 1;

FIG. 3 is an enlarged view of region A in FIG. 2;

FIG. 4 is a view illustrating a cross-section taken along line II-II′ in FIG. 1;

FIG. 5 is a view illustrating a coil component according to a second exemplary embodiment of the present disclosure, and is a view corresponding to FIG. 3;

FIG. 6 is a view illustrating a coil component according to a third exemplary embodiment of the present disclosure, and is a view corresponding to FIG. 3;

FIG. 7 is a view illustrating a coil component according to a fourth exemplary embodiment of the present disclosure, and is a view corresponding to FIG. 3;

FIG. 8 is a view illustrating a coil component according to a fifth exemplary embodiment of the present disclosure, and is a view corresponding to FIG. 3;

FIG. 9 is a view schematically illustrating a manufacturing process sequence of a coil component according to a first exemplary embodiment of the present disclosure; and

FIG. 10 is a view schematically illustrating a manufacturing process sequence according to the related art, and is a view for comparison with FIG. 9.

### DETAILED DESCRIPTION

Hereinafter, exemplary embodiments of the present disclosure will now be described in detail with reference to the accompanying drawings.

In the drawings, an L direction refers to a first direction or length direction, a T direction refers to a second direction or thickness direction, and a W direction refers to a third direction or width direction.

Hereinafter, a coil component according to exemplary embodiments of the present disclosure will be described in detail with reference to the accompanying drawings. In describing the exemplary embodiments of the present disclosure with reference to the accompanying drawings, components that are the same as or correspond to each other will be denoted by the same reference numerals, and overlapping descriptions thereof will be omitted.

Various kinds of electronic components may be used in an electronic device, and various kinds of coil components may be appropriately used between electronic components based on their purposes in order to remove noise or the like.

That is, the coil component used in the electronic device may be a power inductor, high frequency (HF) inductor, a general bead, a bead for a high frequency (GHz), a common mode filter, or the like.

### First Exemplary Embodiment

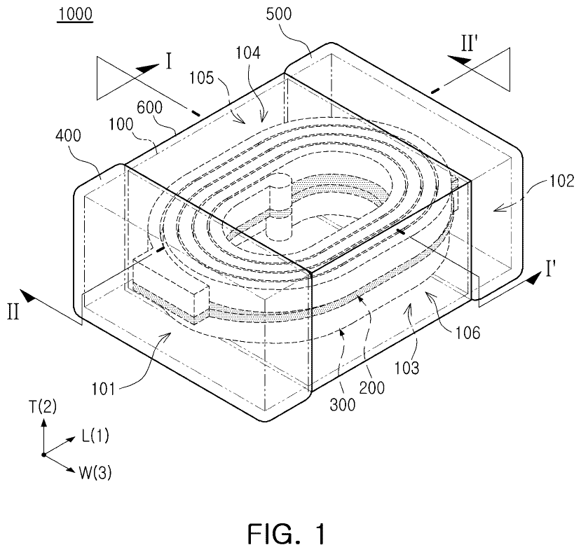

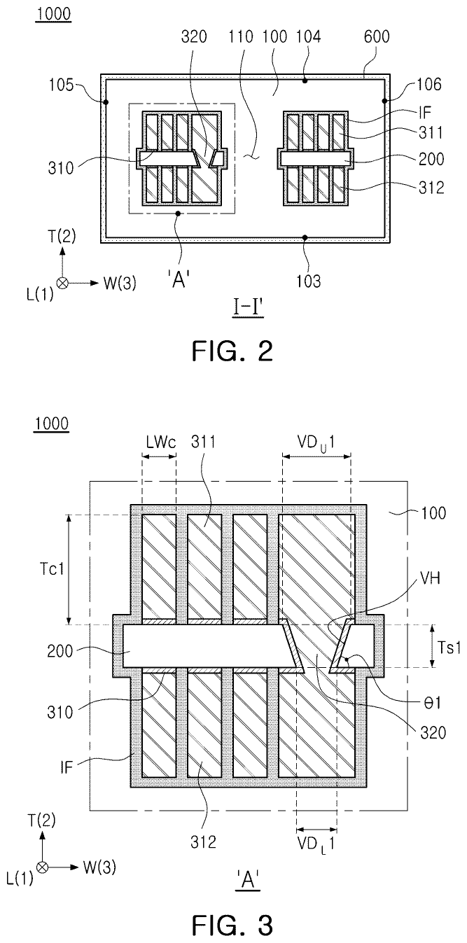

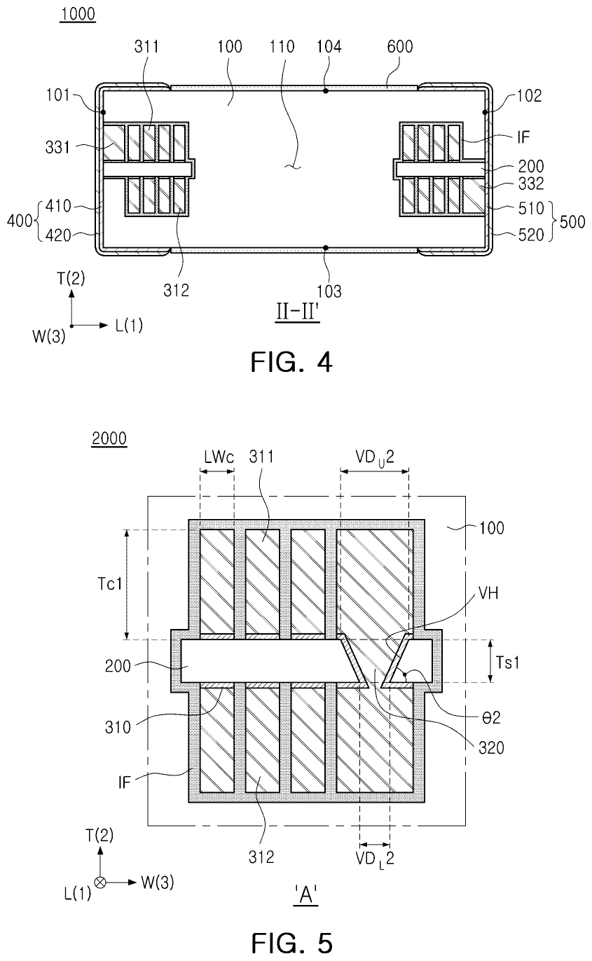

FIG. 1 is a perspective view schematically illustrating a coil component 1000 according to a first exemplary embodiment of the present disclosure; FIG. 2 is a view illustrating a cross-section taken along line I-I′ of FIG. 1; FIG. 3 is an enlarged view of region A of FIG. 2; and FIG. 4 is a view illustrating a cross-section taken along line II-II′ of FIG. 1.

Referring to FIGS. 1 through 4, the coil component 1000 according to a first exemplary embodiment of the present disclosure may include a body 100, a support member 200, a coil 300, and external electrodes 400 and 500.

This thin-film coil component may include a via 320 connecting first and second coil portions 311 and 312 disposed on both surfaces of the support member 200 to each other. In the coil component 1000 according to this exemplary embodiment, the tapered via 320 whose diameter is gradually decreased from the upper to lower surfaces thereof may be formed by irradiating a laser on only one side of the support member 200 to process a via hole VH. In particular, it is possible to reduce void defects occurring in the via 320 during a plating process for filling the via hole VH by controlling a ratio of the maximum diameter to the minimum diameter of the via 320 in a range of 1.06 or more and 1.64 or less.

Hereinafter, the description specifically describes main components included in the coil component 1000 according to this exemplary embodiment.

The body 100 may form an appearance of the coil component 1000 according to this exemplary embodiment, and may embed the support member 200 and the coil 300.

The body 100 may generally have a hexahedral shape.

The body 100 may have a first surface 101 and a second surface 102 opposing each other in the length (L) or first direction, a third surface 103 and a fourth surface 104 opposing each other in the thickness (T) or second direction, and a fifth surface 105 and a sixth surface 106 opposing each other in the width (W) or third direction. The first and second surfaces 101 and 102 and the fifth and sixth surfaces 105 and 106 of the body 100 may each correspond to wall surfaces of the body 100 connecting the third surface 103 and the fourth surface 104 of the body 100 to each other.

For example, the body 100 may be formed for the coil component 1000 according to this exemplary embodiment including the external electrodes 400 and 500 described below to have: a length of 2.5 mm, a width of 2.0 mm, and a thickness of 1.0 mm; a length of 2.0 mm, a width of 1.2 mm, and a thickness of 0.65 mm; a length of 1.6 mm, a width of 0.8 mm, and a thickness of 0.8 mm; a length of 1.4 mm, a width of 1.2 mm, and a thickness of 0.62 mm; a length of 1.0 mm, a width of 0.7 mm, and a thickness of 0.65 mm; a length of 1.0 mm, a width of 0.5 mm, and a thickness of 0.8 mm; or a length of 0.8 mm, a width of 0.4 mm, and a thickness of 0.65 mm. However, the present disclosure is not limited thereto. Meanwhile, the above exemplary dimensions for the length, width, and thickness of the coil component 1000 may be dimensions that do not reflect process errors, and a range of the dimensions recognized to include the process errors may thus fall within that of the above-described exemplary dimensions.

The above length of the coil component 1000 may indicate the maximum value of respective dimensions of a plurality of line segments spaced apart from each other in the thickness (T) direction, and connecting two outermost boundary lines opposing each other in the length (L) direction of the coil component 1000 shown in the following image to be parallel to the length (L) direction, based on the optical microscope image or scanning electron microscope (SEM) image of a cross-section of the coil component 1000 in a length (L)-thickness (T) direction that is taken from its center in the width (W) direction. Other methods and/or tools appreciated by one of ordinary skill in the art, even if not described in the present disclosure, may also be used. Alternatively, the length of the coil component 1000 may indicate the minimum value of the respective dimensions of the plurality of line segments described above. Alternatively, the length of the coil component 1000 may indicate an arithmetic average value of at least three of the respective dimensions of the plurality of line segments described above. Here, the plurality of line segments parallel to the length (L) direction may be equally spaced from each other in the thickness (T) direction, and the scope of the present disclosure is not limited thereto.

The above thickness of the coil component 1000 may indicate the maximum value of respective dimensions of a plurality of line segments spaced apart from each other in the length (L) direction, and connecting two outermost boundary lines opposing each other in the thickness (T) direction of the coil component 1000 shown in the following image to be parallel to the thickness (T) direction, based on the optical microscope image or scanning electron microscope (SEM) image of the cross-section of the coil component 1000 in the length (L)-thickness (T) direction that is taken from its center in the width (W) direction. Other methods and/or tools appreciated by one of ordinary skill in the art, even if not described in the present disclosure, may also be used. Alternatively, the thickness of the coil component 1000 may indicate the minimum value of the respective dimensions of the plurality of line segments described above. Alternatively, the thickness of the coil component 1000 may indicate an arithmetic average value of at least three of the respective dimensions of the plurality of line segments described above. Here, the plurality of line segments parallel to the thickness (T) direction may be equally spaced from each other in the length (L) direction, and the scope of the present disclosure is not limited thereto.

The above width of the coil component 1000 may indicate the maximum value of respective dimensions of a plurality of line segments spaced apart from each other in the length (L) direction, and connecting two outermost boundary lines opposing each other in the width (W) direction of the coil component 1000 shown in the following image to be parallel to the width (W) direction, based on the optical microscope image or scanning electron microscope (SEM) image of a cross-section of the coil component 1000 in a length (L)-width (W) direction that is taken from its center in the thickness (T) direction. Other methods and/or tools appreciated by one of ordinary skill in the art, even if not described in the present disclosure, may also be used. Alternatively, the width of the coil component 1000 may indicate the minimum value of the respective dimensions of the plurality of segments line described above. Alternatively, the width of the coil component 1000 may indicate an arithmetic average value of at least three of the respective dimensions of the plurality of line segments described above. Here, the plurality of line segments parallel to the width (W) direction may be equally spaced from each other in the length (L) direction, and the scope of the present disclosure is not limited thereto.

Alternatively, each of the length, width and thickness of the coil component 1000 may be measured using a micrometer measurement method. The micrometer measurement method may be used by setting a zero point with a micrometer using a repeatability and reproducibility (Gage R&R), inserting the coil component 1000 according to this exemplary embodiment between tips of the micrometer, and turning a measurement lever of the micrometer. Meanwhile, when measuring the length of the coil component 1000 by using the micrometer measurement method, the length of the coil component 1000 may indicate a value measured once or an arithmetic average of values measured several times. This method may be equally applied to measure the width or thickness of the coil component 1000.

The body 100 may include a magnetic material and resin. In detail, the body 100 may be formed by laminating one or more magnetic composite sheets in which the magnetic material is dispersed in the resin. However, the body 100 may also have a structure other than the structure in which the magnetic material is dispersed in the resin. For example, the body 100 may be made of a magnetic material such as ferrite or a non-magnetic material.

The magnetic material may be the ferrite or metal magnetic powder particles.

The ferrite may be, for example, at least one of a spinel type ferrite such as Mg—Zn-based ferrite, Mn—Zn-based ferrite, Mn—Mg-based ferrite, Cu—Zn-based ferrite, Mg—Mn—Sr-based ferrite or Ni—Zn-based ferrite, a hexagonal type ferrite such as Ba—Zn-based ferrite, Ba—Mg-based ferrite, Ba—Ni-based ferrite, Ba—Co-based ferrite or Ba—Ni—Co-based ferrite, a garnet type ferrite such as Y-based ferrite, and Li-based ferrite.

The metal magnetic powder particles may include one or more selected from the group consisting of iron (Fe), silicon (Si), chromium (Cr), cobalt (Co), molybdenum (Mo), aluminum (Al), niobium (Nb), copper (Cu) and nickel (Ni). For example, the metal magnetic powder particles may be one or more of pure iron powder particles, Fe—Si-based alloy powder particles, Fe—Si—Al-based alloy powder particles, Fe—Ni-based alloy powder particles, Fe—Ni—Mo-based alloy powder particles, Fe—Ni—Mo—Cu-based alloy powder particles, Fe—Co-based alloy powder particles, Fe—Ni—Co-based alloy powder particles, Fe—Cr-based alloy powder particles, Fe—Cr—Si-based alloy powder particles, Fe—Si—Cu—Nb-based alloy powder particles, Fe—Ni—Cr-based alloy powder particles, and Fe—Cr—Al-based alloy powder particles.

The metal magnetic powder particles may be amorphous or crystalline. For example, the metal magnetic powder particles may be Fe—Si—B—Cr-based amorphous alloy powder particles, and are not necessarily limited thereto.

The ferrite and the metal magnetic powder particles may respectively have average diameters of about 0.1 μm to 30 μm, and are not limited thereto.

The body 100 may include two or more types of magnetic materials dispersed in the resin. Here, different types of magnetic materials may indicate that the magnetic materials dispersed in the resin are distinguished from each other by any one of an average diameter, a composition, crystallinity, and a shape.

The resin may include epoxy, polyimide, liquid crystal polymer (LCP), or the like, or mixtures thereof, and is not limited thereto.

The body 100 may have a core 110 passing through the support member 200 and the coil 300. The core 110 may be formed by filling a through-hole of the support member 200 with the magnetic composite sheet, and is not limited thereto.

The support member 200 may be disposed in the body 100. The support member 200 is a component supporting the coil 300 described below. Meanwhile, in some embodiments, at least a portion of the support member 200 may be removed after the coil 300 is formed when the coil 300 has a coreless structure.

Referring to FIG. 3, the support member 200 may be disposed in the body 100, and have one surface and the other surface opposing each other. One surface of the support member 200 may correspond to an upper surface and the other surface may correspond to a lower surface, based on the directions shown in FIG. 3.

The support member 200 may include the via hole VH passing through the support member 200, and the via 320 may be disposed in an inner space of the via hole VH. The via 320 of this exemplary embodiment may include a seed layer 310, and at least a portion of the seed layer 310 may be disposed along the inner surface of the via hole VH.

Referring to FIG. 3, the inner surface of the via hole VH formed in the support member 200 may be inclined to have an acute angle with the other surface (or lower surface) of the support member 200. In this exemplary embodiment, a predetermined angle θ1 narrower than 90 degrees may be formed between the inner surface of the via hole VH and the other surface of the support member 200.

Here, the angle θ1 formed between the inner surface of the via hole VH and the other surface of the support member 200 may indicate an arithmetic average value of values measured from each of two sides of the via 320 for the angle between the inner surface of the via hole VH and the lower surface of the support member 200 shown in the following image, based on the optical microscope image or scanning electron microscope (SEM) image of a W-T cross-section of the coil component 1000 taken from its center in the first (or L) direction. Here, an irregularities may exist on the surface of the support member 200 and the inner surface of the via hole VH. In this case, it is possible to use Image J which is a program tool to thus draw respective center lines on the surface of the support member 200 and the inner surface of the via hole VH, and measure an angle between these center lines. However, the scope of this exemplary embodiment is not limited thereto. Other methods and/or tools appreciated by one of ordinary skill in the art, even if not described in the present disclosure, may also be used.

A thickness Ts1 between one surface and the other surface of the support member 200 in this exemplary embodiment may be 5 μm or more, or may be 10 μm or more and 45 μm or less.

A thickness of the via 320 may also be less than 5 μm when the thickness Ts1 of the support member 200 is less than 5 μm. In this case, the proportion of via 320 in the coil 300 may be very small, and a shape of via 320 may be close to a straight line, thus lowering an effect of reducing the voids in the via 320 by the tapered shape. Meanwhile, the effect of reducing the voids in the via 320 by the tapered shape may be more clearly seen when the thickness Ts1 of the support member 200 is 10 μm or more.

On the other hand, the thickness Ts1 of the support member 200 may be more than 45 μm. In this case, it may be difficult to form the via hole VH by irradiating only one side of the support member 200 when processing the via hole VH by using a laser, thus requiring a process of processing the via hole VH in each of the two surfaces of the support member 200. Only one side of the support member 200 may be processed. Even in this case, a diameter of the via hole VH in the other surface may be greatly reduced than the diameter of the via hole VH in one surface, thus increasing a possibility of the void defect occurring in the via 320 during the plating process.

Therefore, the thickness Ts1 between one surface and the other surface of the support member 200 may be 5 μm or more and 45 μm or less, and the effect of reducing the voids in the via 320 by the taper shape may be more clearly shown when the thickness Ts1 is 10 μm or more and 45 μm or less.

Here, the thickness Ts1 between one surface and the other surface of the support member 200 may indicate an arithmetic average value of at least three of respective dimensions of a plurality of line segments spaced apart from each other in the third or W direction, and connecting two outermost boundary lines opposing each other in the second or T direction of the support member 200 shown in the following image to be parallel to the second or T direction, based on the optical microscope image or scanning electron microscope (SEM) image of a W-T cross-section of the coil component 1000 that is taken from its center in the first or L direction. Other methods and/or tools appreciated by one of ordinary skill in the art, even if not described in the present disclosure, may also be used. Here, the plurality of line segments parallel to the second or T direction may be equally spaced from each other in the third or W direction, and the scope of the present disclosure is not limited thereto.

The support member 200 may be made of an insulating material including thermosetting insulating resin such as epoxy resin, thermoplastic insulating resin such as polyimide, or photosensitive insulating resin, or may be made of an insulating material having a reinforcement material such as a glass fiber or an inorganic filler impregnated in the insulating resin. For example, the support member 200 may be made of a material such as prepreg, an Ajinomoto Build-up Film (ABF), FR-4, bismaleimide triazine (BT) resin, a photo imagable dielectric (PID) or a copper clad laminate (CCL), and is not limited thereto.

The inorganic filler may use one or more materials selected from the group consisting of silica (or silicon dioxide, SiO₂), alumina (or aluminum oxide, Al₂O₃), silicon carbide (Sic), barium sulfate (BaSO₄), talc, clay, mica powder particles, aluminum hydroxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃), and calcium zirconate (CaZrO₃).

Here, when made of the insulating material including the reinforcing material, the support member 200 may have more excellent rigidity. The support member 200 may be made of the insulating material including no glass fiber. In this case, an entire thickness of the support member 200 and the coil 300 (indicating sum of the respective dimensions of the coil 300 and the support member 200 in the second or T direction of FIG. 1) may be thinned, which is advantageous in reducing the thickness of the component. The support member 200 may be made of the insulating material including the photosensitive insulating resin. In this case, the number of processes for forming the coil 300 may be reduced, which is advantageous in reducing a production cost, and the fine via 320 may also be formed.

The coil 300 may be disposed on support member 200. The coil 300 may be embedded in the body 100 to express a characteristic of the coil component. For example, when the coil component 1000 of this exemplary embodiment is used as the power inductor, the coil 300 may store an electric field as a magnetic field to maintain an output voltage, thereby stabilizing power of the electronic device.

The coil 300 may be disposed on one surface and the other surface of the support member 200 that oppose each other, and have at least one turn. The coil 300 of this exemplary embodiment may include the first and second coil portions 311 and 312, and the via 320, and may further include first and second lead portions 331 and 332.

Referring to FIGS. 1 through 4, the first coil portion 311 or the second coil portion 312 may be disposed on each of the two surfaces of the support member 200 that oppose each other, and may thus have a shape of a planar spiral in which at least one turn is wound around the core 110 of the body 100.

For example, the first coil portion 311 may be disposed on the upper surface of the support member 200 to have at least one turn wound around the core 110 based on the directions shown in FIG. 1. In addition, the second coil portion 312 may be disposed on the lower surface of the support member 200 to have at least one turn wound around the core 110.

The first or second coil portion 311 or 312 may have the outermost turn end which extends to the first or second surface 101 or 102 of the body 100 to be connected to the first or second lead portion 331 or 332.

An aspect ratio of each turn of the first and second coil portions 311 and 312 in this exemplary embodiment may be 4.5 or more. In detail, referring to FIG. 3, a ratio Tc/LWc of a thickness Tc of each turn of the first and second coil portions 311 and 312 in the second direction to a line width LWc of each turn of the first and second coil portions 311 and 312 may be 4.5 or more on the W-T cross-section of the coil component, passing through the center of the body 100 and perpendicular to the first or L direction. In addition, the aspect ratio of each turn of the first and second coil portions 311 and 312 may be 6 or more. The thickness Tc and line width LWc may be measured from an optical microscope image or an scanning electron microscope (SEM) image of a W-T cross-section of the coil component 1000 that is taken from its center in the first or L direction to pass through the center of the coil 300. Other methods and/or tools appreciated by one of ordinary skill in the art, even if not described in the present disclosure, may also be used.

Meanwhile, the aspect ratio of each turn of the first and second coil portions 311 and 312 may be 15 or less, and the scope of this exemplary embodiment is not limited thereto.

As described above, when the aspect ratio of each turn of the first and second coil portions 311 and 312 is as high as 4.5 or more, even a coil component of the same size that has an inner coil having the same number of turns may have an increased inductance capacity and a reduced direct current (DC) resistance (Rdc). In particular, when the aspect ratio of each turn of the first and second coil portions 311 and 312 is as high as 6 or more, a coil component having the same volume may have a further improved electrical characteristic.

When the support member 200 is made thin like the coil component 1000 according to this exemplary embodiment, the coil component 1000 of the same size may have an increased effective volume, and secure a space to have a high aspect ratio of the coil 300.

Referring to FIGS. 2 and 3, the via 320 included in the coil 300 is a component connecting the first and second coil portions 311 and 312 to each other. In detail, the via 320 may pass through the support member 200 to connect the innermost turn end of the first coil portion 311 and the innermost turn end of the second coil portion 312 to each other.

The via 320 of this exemplary embodiment may include the upper surface in contact with the first coil portion 311 and the lower surface in contact with the second coil portion 312, and a ratio VD_{U}/VD_{L} of a diameter VD_{U} of the upper surface of the via 320 to the diameter VD_{L} of the lower surface of the via 320 may be 1.06 or more and 1.64 or less.

Meanwhile, referring to FIG. 3, the innermost turn of the first and second coil portion 311 or 312 and the via 320 may be integrally formed with each other, and an interface therebetween may not appear. However, in the specification, for convenience of explanation, in an inner region of the via hole VH passing through the support member 200, an extending surface of one surface of the support member 200 is defined as the upper surface of the via 320, and an extending surface of the other surface of the support member 200 is defined as the lower surface of the via 320. In FIG. 3, the upper and lower surfaces of the via 320 are shown as dotted lines parallel to the third or W direction, and the via 320 may indicate a component disposed between the dotted-line region of the inner surface of the via hole VH and the upper and lower surfaces, including the seed layer 310.

Here, the diameter VD_{U} or VD_{L} of the via 320 may indicate an arithmetic average value of at least three of respective dimensions of a plurality of line segments spaced apart from each other in the second or T direction, and connecting two outermost boundary lines in both the sides of the via 320 shown in the following image to be parallel to the third or W direction, based on the optical microscope image or scanning electron microscope (SEM) image of a W-T cross-section of the coil component 1000 that is taken from its center in the first or L direction to pass through the center of the via 320. Other methods and/or tools appreciated by one of ordinary skill in the art, even if not described in the present disclosure, may also be used. Here, the plurality of line segments parallel to the third or W direction may be equally spaced from each other in the second or T direction, and the scope of the present disclosure is not limited thereto.

Tables 1 to 4 below show experimental data acquired by checking occurrence of the void defect or short-circuit defect by changing the ratio VD_{U}/VD_{L} of the diameter VD_{U} of the upper surface of the via 320 to the diameter VD_{L} of the lower surface of the via 320.

Meanwhile, occurrence frequency of the void defects and the like may be different when the thickness Ts1 of the support member 200 is different even though the ratio VD_{U}/VD_{L} of the diameter VD_{U} of the upper surface of the via 320 to the diameter VD_{L} of the lower surface of the via 320 is the same. Accordingly, the occurrences of the defects are checked by fixing the thickness of the support member 200 to 10 μm (Table 1), 20 μm (Table 2), 30 μm (Table 3), or 40 μm (Table 4), and changing the ratio VD_{U}/VD_{L} of the diameter VD_{U} of the upper surface of the via 320 to the diameter VD_{L} of the lower surface of the via 320.

In each experiment, it is described as “NG” when the void defect or the short-circuit defect occurs in at least 1 sample out of 10 samples, and it is described as “OK” when no defect occurs. Here, the void defect is defined as the observation of at least one void which can be seen by the naked eye based on an SEM photograph at 200× magnification. The sample used in the experiment is a coil component with dimensions of a length of 1.0 mm, a width of 0.7 mm, and a thickness of 0.65 mm.

TABLE 1
Thickness Ts1 of support member = 10 μm

| VD_{U}/VD_{L} | Void defect | Short-circuit defect |
|---|---|---|
| 0.74 | OK | NG |
| 0.85 | OK | NG |
| 0.95 | OK | NG |
| 1.06 | OK | OK |
| 1.2 | OK | OK |
| 1.37 | OK | OK |
| 1.45 | OK | OK |
| 1.52 | OK | OK |
| 1.62 | OK | OK |
| 1.76 | NG | OK |

TABLE 2
Thickness Ts1 of support member = 20 μm

| VD_{U}/VD_{L} | Void defect | Short-circuit defect |
|---|---|---|
| 0.89 | OK | NG |
| 0.94 | OK | NG |
| 1.06 | OK | OK |
| 1.1 | OK | OK |
| 1.23 | OK | OK |
| 1.45 | OK | OK |
| 1.52 | OK | OK |
| 1.64 | OK | OK |
| 1.76 | NG | OK |
| 1.89 | NG | OK |

TABLE 3
Thickness Ts1 of support member = 30 μm

| VD_{U}/VD_{L} | Void defect | Short-circuit defect |
|---|---|---|
| 0.87 | OK | NG |
| 0.93 | OK | NG |
| 1.07 | OK | OK |
| 1.18 | OK | OK |
| 1.3 | OK | OK |
| 1.47 | OK | OK |
| 1.62 | OK | OK |
| 1.72 | NG | OK |
| 1.84 | NG | OK |
| 1.98 | NG | OK |

TABLE 4
Thickness Ts1 of support member = 40 μm

| VD_{U}/VD_{L} | Void defect | Short-circuit defect |
|---|---|---|
| 0.93 | OK | NG |
| 1.06 | OK | OK |
| 1.21 | OK | OK |
| 1.39 | OK | OK |
| 1.53 | OK | OK |
| 1.63 | OK | OK |
| 1.79 | NG | OK |
| 1.93 | NG | OK |
| 2.06 | NG | OK |
| 2.24 | NG | OK |

Referring to Tables 1 to 4 above, it is observed that the diameter VD_{L} of the lower surface of the via 320 is increased to cause the short-circuit defect occurring between the turn of the second coil portion 312 adjacent to its innermost turn and the via 320 when the ratio VD_{U}/VD_{L} of the diameter VD_{U} of the upper surface of the via 320 to the diameter VD_{L} of the lower surface of the via 320 is less than 1.06.

On the other hand, it is observed that the void defect occurs in the via 320 when the ratio VD_{U}/VD_{L} of the diameter VD_{U} of the upper surface of the via 320 to the diameter VD_{L} of the lower surface of the via 320 is greater than 1.64.

Slight differences exist in an occurrence range of the void defects or short-circuit defects based on the thickness Ts1 of the support member 200. However, it may be commonly confirmed in the cases of Tables 1 to 4 that none of the void defects and short-circuit defects occurs when the ratio VD_{U}/VD_{L} of the diameter VD_{U} of the upper surface of the via 320 to the diameter VD_{L} of the lower surface of the via 320 is 1.06 or more and 1.64 or less.

Referring to FIG. 3, the via 320 of this exemplary embodiment may have a smaller diameter as being closer to the other surface of the support member 200. That is, via 320 may have the tapered shape to thus have a smaller diameter in the other surface region of the support member 200 than in the central region of the support member 200.

Through the above structure, the plating process for filling the via hole VH may be performed more smoothly, and the processing may be performed on only one surface of the support member 200 when forming the via hole VH, thus improving the process efficiency and lowering a defect rate compared to a case of performing the processing on both the surfaces.

Referring to FIG. 3, the via 320 of this exemplary embodiment may include the seed layer 310, and the seed layer 310 may pass through the via hole VH. In detail, the seed layers 310 may be integrally disposed along one surface of the support member 200, the inner surface of the via hole VH, and the other surface of the support member 200.

Referring to FIGS. 1 and 4, the first lead portion 331 may extend from the outermost turn of the first coil portion 311 to the first surface 101 of the body 100, and the second lead portion 332 may extend from the outermost turn of the second coil portion 312 to the second surface 102 of the body 100.

In addition, the first lead portion 331 may be connected to the first external electrode 400 disposed on the first surface 101 of the body 100, and the second lead portion 332 may be connected to the second external electrode 500 disposed on the second surface 102 of the body 100.

Therefore, a signal input to the first external electrode 400 may be output to the second external electrode 500 through the first lead portion 331, the first coil portion 311, the via 320, the second coil portion 312, and the second lead portion 332. Through this structure, the respective components of the coil 300 may entirely function as one coil connected between the first and second external electrodes 400 and 500.

At least one of the first and second coil portions 311 and 312, the via 320, and the first and second lead portions 331 and 332 may include at least one conductive layer.

For example, the first coil portion 311, the via 320, and the first lead portion 331 may be formed by performing the plating on the lower surface of the support member 200 (based on the directions shown in FIG. 1). In this case, each of the first coil portion 311, the via 320, and the first lead portion 331 may include the seed layer 310 and an electroplating layer. The seed layer 310 may be formed by a vapor deposition method such as electroless plating or sputtering. Each of the seed layer 310 and the electroplating layer may have a single-layer structure or a multi-layer structure. The electroplating layer having the multi-layer structure may be a conformal film in which another electroplating layer covers one electroplating layer, or may be a layer in which another electroplating layer is laminated on only one surface of one electroplating layer. The seed layer 310 of the first coil portion 311, the seed layer 310 of the via 320, and the seed layer 310 of the first lead portion 331 may be integrally formed to thus have no boundary therebetween, and are not limited thereto. The electroplating layer of the first coil portion 311, the electroplating layer of the via 320, and the electroplating layer of the first lead portion 331 may be integrally formed to thus have no boundary therebetween, and are not limited thereto.

Each of the first and second coil portions 311 and 312, the via 320, and first and second lead portions 331 and 332 may be made of a conductive material such as copper (Cu), aluminum (Al), silver (Ag), tin (Sn), gold (Au), nickel (Ni), lead (Pb), titanium (Ti), chromium (Cr), molybdenum (Mo), or an alloy thereof, and is not limited thereto.

The first and second external electrodes 400 and 500 may respectively be disposed on the first surface 101 and the second surface 102 of the body 100, and respectively connected to the first and second lead portions 331 and 332. In detail, the first external electrode 400 may be disposed on the first surface 101 of the body 100 and in contact with the first lead portion 331. In addition, the second external electrode 500 may be disposed on the second surface 102 of the body 100 and in contact with the second lead portion 332.

The external electrodes 400 and 500 may electrically connect the coil component 1000 to a printed circuit board or the like when the coil component 1000 according to this exemplary embodiment is mounted on the printed circuit board or the like. For example, each of the external electrodes 400 and 500 disposed on the first surface 101 and the second surface 102 of the body 100 while being spaced apart from each other may be electrically connected to a connection part of the printed circuit board.

Meanwhile, referring to FIGS. 1 and 4, the first and second external electrodes 400 and 500 of this exemplary embodiment are respectively disposed on the five surfaces of the body 100, and are not limited thereto.

That is, in the coil component 1000 according to this exemplary embodiment, the first external electrode 400 may be disposed on the first surface 101 and third to fifth surfaces 103, 104, 105, and 106 of the body 100, and the second external electrode 500 may be disposed on the second to fifth surfaces 102, 103, 104, 105, and 106 of the body 100. However, the present disclosure is not limited to, and the first and second external electrodes 400 and 500 may be disposed only in some regions of the third to sixth surfaces 103, 104, 105, and 106 of the body 100.

In detail, the first and second external electrodes 400 and 500 respectively disposed on the first surface 101 and second surface 102 of the body 100 may at least partially extend to the third surface 103 of the body 100. In addition, each of the first and second external electrodes 400 and 500 may at least partially extend to the fourth to sixth surfaces 104, 105, and 106 of the body 100.

Each of the external electrodes 400 and 500 may be made of a conductive material such as copper (Cu), aluminum (Al), tin (Sn), nickel (Ni), lead (Pb), chromium (Cr), titanium (Ti), or an alloy thereof. In addition, each of the external electrodes 400 and 500 may include a noble metal such as palladium (Pd), silver (Ag), platinum (Pt), gold (Au), or an alloy thereof, and is not limited thereto.

Each of the external electrodes 400 and 500 may include a plurality of layers.

For example, the first external electrode 400 may include a first layer 410 in contact with the first lead portion 331 and a second layer 420 disposed on the first layer 410. Here, the first layer 410 may be a conductive resin layer including conductive powder particles including at least one of copper (Cu) and silver (Ag) and insulating resin, or may be a copper (Cu) plating layer. The second layer 420 may have a double layer structure of a nickel (Ni) plating layer and/or a tin (Sn) plating layer.

Similarly, the second external electrode 500 may include a first layer 510 in contact with the second lead portion 332 and a second layer 520 disposed on the first layer 510. Here, the first layer 510 may be the conductive resin layer including the conductive powder particles including at least one of copper (Cu) and silver (Ag) and the insulating resin, or may be the copper (Cu) plating layer. The second layer 520 may have the double layer structure of the nickel (Ni) plating layer and/or the tin (Sn) plating layer.

Referring to FIGS. 2 through 4, an insulating film IF may be disposed between the coil 300 and the body 100 to cover the coil 300. The insulating film IF may be disposed along the surfaces of the support member 200 and the coil 300. That is, the insulating film IF may integrally cover the support member 200 and the coil 300.

In addition, referring to FIG. 3, the insulating film IF of this exemplary embodiment may be in contact with at least a portion of the seed layer 310. For example, in this exemplary embodiment, the plating process may be performed by removing a portion of a copper clad from the copper clad laminate, and using the other portion as the seed layer 310 when forming the coil 300. Therefore, a side surface of the seed layer 310 may be exposed without being plated, and the insulating film IF may then be disposed. As a result, at least a portion of the seed layer 310 may be in contact with the insulating film.

The insulating film IF may be used for insulating the coil 300 from the body 100, and include a well-known insulating material such as paraline. However, the present disclosure is not limited thereto. The insulating film IF may be formed by the vapor deposition method or the like, is not limited thereto, and may be formed by laminating an insulating film on both the surfaces of the support member 200.

Meanwhile, the coil component 1000 according to this exemplary embodiment may further include an insulating layer disposed in a region other than the regions where the external electrodes 400 and 500 are disposed while covering the third to sixth surfaces 103, 104, 105, and 106 of the body 100.

The insulating layer may be formed, for example, by coating and curing an insulating material including the insulating resin on the surface of the body 100. In this case, the insulating layer may include at least one of thermoplastic resin such as polystyrene-based resin, vinyl acetate-based resin, polyester-based resin, polyethylene-based resin, polypropylene-based resin, polyamide-based resin, rubber-based resin, acrylic-based resin, thermosetting insulating resin such as phenol-based resin, epoxy-based resin, urethane-based resin, melamine-based resin, and alkyd-based resin, and the photosensitive insulating resin.

### Second and Third Exemplary Embodiments

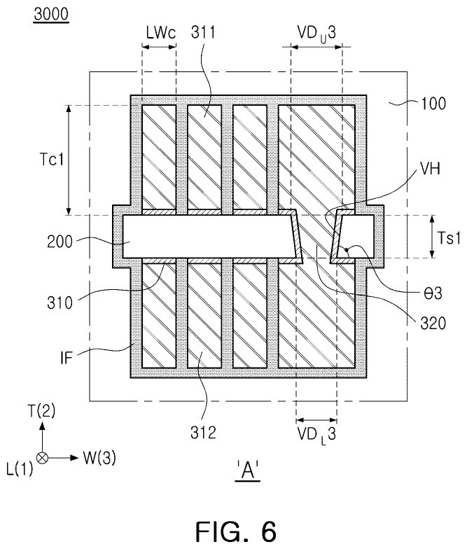

FIG. 5 is a view illustrating a coil component 2000 according to a second exemplary embodiment of the present disclosure, and is a view corresponding to FIG. 3; and FIG. 6 is a view illustrating a coil component 3000 according to a third exemplary embodiment of the present disclosure, and is a view corresponding to FIG. 3.

When respectively comparing FIGS. 5 and 6 with FIG. 3, the exemplary embodiments are different from one another in an inclination angle of the tapered via formed in the support member 200 and the upper and lower diameters of the via 320.

Therefore, in describing these exemplary embodiments, the inclination angle of the tapered via formed in the support member 200 and the upper and lower diameters of the via 320, which are different from those in a first exemplary embodiment of the present disclosure, are only described, and the descriptions of the other configurations in a first exemplary embodiment of the present disclosure may be equally applied to descriptions of those in these exemplary embodiments.

Referring to FIG. 5, the thickness Ts1 of the support member 200 of the coil component 2000 according to this exemplary embodiment is the same as the thickness Ts1 of the support member 200 in a first exemplary embodiment, and an inclination angle θ2 between the inner surface of the via hole VH and the other surface of the support member 200 may be smaller than the inclination angle θ1 in a first exemplary embodiment.

Accordingly, in this exemplary embodiment, a diameter VD_{U}2 of the upper surface of the via 320 may be greater than that in a first exemplary embodiment, and the diameter VD_{L}2 of the lower surface of the via 320 may be smaller than that in a first exemplary embodiment. Therefore, the ratio VD_{U}/VD_{L} of the diameter VD_{U} of the upper surface of the via 320 to the diameter VD_{L} of the lower surface of the via 320 may have a larger value than that in a first exemplary embodiment.

In this exemplary embodiment, a plating growth may be smooth on the upper surface of the via 320, and a risk of the short-circuit defect occurring with the adjacent turns on the lower surface of the via 320 may be lower.

Referring to FIG. 6, the thickness Ts1 of the support member 200 of the coil component 3000 according to this exemplary embodiment is the same as the thickness Ts1 of the support member 200 in a first exemplary embodiment, and an inclination angle θ3 between the inner surface of the via hole VH and the other surface of the support member 200 may be greater than the inclination angle θ1 in a first exemplary embodiment. The inclination angle θ3 formed between the inner surface of the via hole VH and the other surface of the support member 200 may be close to 90 degrees, and may be an acute angle smaller than 90 degrees.

In this exemplary embodiment, a diameter VD_{U}3 of the upper surface of the via 320 may be smaller than that in a first exemplary embodiment, and the diameter VD_{L}3 of the lower surface of the via 320 may be greater than that in a first exemplary embodiment. Therefore, the ratio VD_{U}/VD_{L} of the diameter VD_{U} of the upper surface of the via 320 to the diameter VD_{L} of the lower surface of the via 320 may have a smaller value than that in the first embodiment.

In this exemplary embodiment, it is possible to sufficiently secure a region where the seed layer 310 is disposed on one surface of the support member 200 that is adjacent to the upper surface of the via 320, thus promoting a smooth plating growth of a part of the first coil portions 311 that is in contact with the upper surface of the via 320.

### Fourth and Fifth Exemplary Embodiments

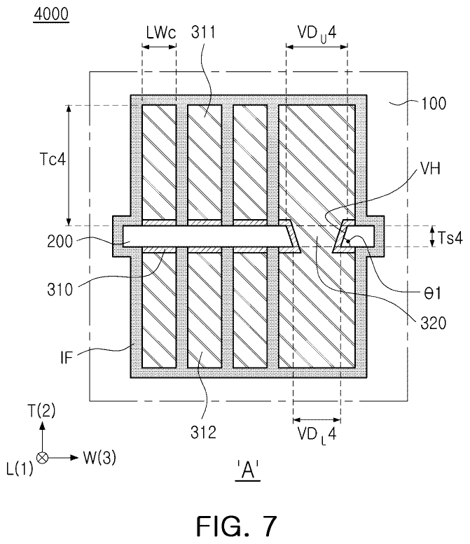

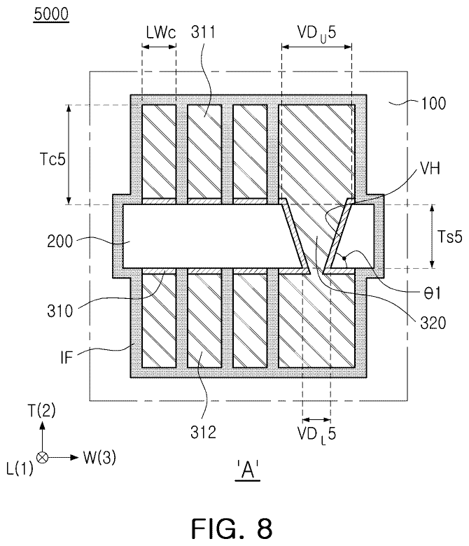

FIG. 7 is a view illustrating a coil component 4000 according to a fourth exemplary embodiment of the present disclosure, and is a view corresponding to FIG. 3; and FIG. 8 is a view illustrating a coil component 5000 according to a fifth exemplary embodiment of the present disclosure, and is a view corresponding to FIG. 3.

When respectively comparing FIGS. 7 and 8 with FIG. 3, the exemplary embodiments are different from one another in the thickness of the support member 200 and the upper and lower diameters of the via 320.

Therefore, in describing these exemplary embodiments, the thickness of the support member 200 and the upper and lower diameters of the via 320, which are different from those in a first exemplary embodiment of the present disclosure, are only described, and the descriptions of the other configurations in a first exemplary embodiment in the present disclosure may be equally applied to descriptions of those in these exemplary embodiments.

Referring to FIG. 7, the inclination angle θ1 formed between the inner surface of the via hole VH and the other surface of the support member 200 of the coil component 4000 according to this exemplary embodiment is the same as the inclination angle θ1 in a first exemplary embodiment, and a thickness Ts4 of the support member 200 may be smaller than the thickness Ts1 of the support member 200 in a first exemplary embodiment.

Accordingly, in this exemplary embodiment, a diameter VD_{U}4 of the upper surface of the via 320 may be smaller than that in a first exemplary embodiment, and the diameter VD_{L}4 of the lower surface of the via 320 may be greater than that in a first exemplary embodiment despite the same inclination angle θ1. Therefore, the ratio VD_{U}/VD_{L} of the diameter VD_{U} of the upper surface of the via 320 to the diameter VD_{L} of the lower surface of the via 320 may have a smaller value than that in a first exemplary embodiment.

In this exemplary embodiment, the coil component 4000 may be thinned by the smaller thickness Ts4 of the support member 200. Therefore, when assuming a coil component has the same size, the coil component may have the coil portions 311 and 312 each having a greater thickness Tc4, thus forming the coil 300 having a higher aspect ratio. It is thus possible to improve the inductance characteristics and/or reduce the Rdc even though the coil 300 has the same number of turns.

Referring to FIG. 8, the inclination angle θ1 formed between the inner surface of the via hole VH and the other surface of the support member 200 of the coil component 5000 according to this exemplary embodiment is the same as the inclination angle θ1 in a first exemplary embodiment, and a thickness Ts5 of the support member 200 may be greater than the thickness Ts1 of the support member 200 in a first exemplary embodiment.

Accordingly, in this exemplary embodiment, a diameter VD_{U}5 of the upper surface of the via 320 may be greater than that in a first exemplary embodiment, and the diameter VD_{L}5 of the lower surface of the via 320 may be smaller than that in a first exemplary embodiment despite the same inclination angle θ1. Therefore, the ratio VD_{U}/VD_{L} of the diameter VD_{U} of the upper surface of the via 320 to the diameter VD_{L} of the lower surface of the via 320 may have a greater value than that in a first exemplary embodiment.

In this exemplary embodiment, the support member 200 may have the greater thickness Ts5 to widen a coupling area of the support member 200 with the body 100, thus stably supporting the coil 300, and the coil portions 311 and 312 may each have a smaller thickness Tc5 to facilitate the plating growth and shorten a process time, thus improving production efficiency.

### Manufacturing Process and Comparison with Related Art

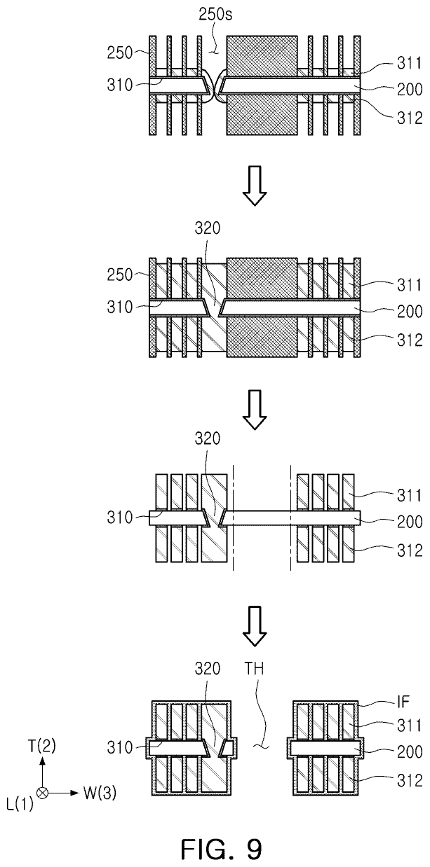

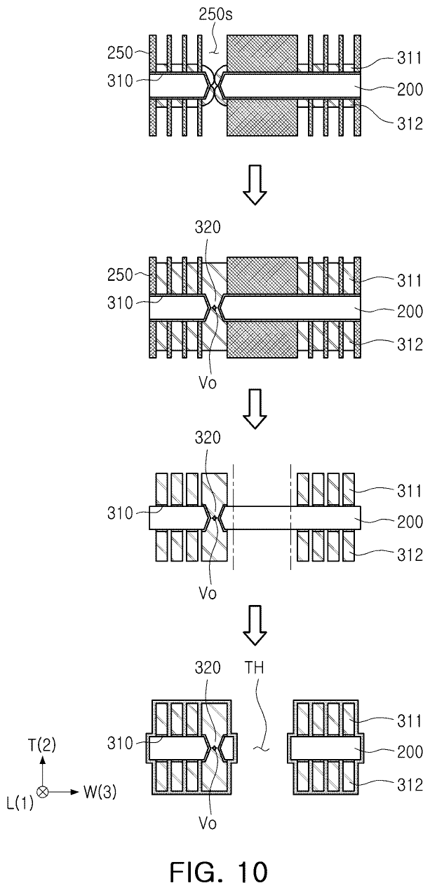

FIG. 9 is a view schematically illustrating each manufacturing process sequence of the coil components 1000, 2000, 3000, 4000, and 5000 according to the exemplary embodiments of the present disclosure; and FIG. 10 is a view schematically illustrating a manufacturing process sequence according to the related art, and is a view for comparison with FIG. 9.

Referring to FIG. 9, in the copper clad laminate on which a partition wall 250 forming a pattern is disposed, first and second coil portions 311 and 312 and the via 320 may be formed on the seed layer 310 by using an opening 250s of the partition wall 250 as a plating growth guide. Here, the via hole where the via 320 is disposed may have the tapered shape with a smaller diameter toward the lower surface. Therefore, the plating may be smoothly performed with no void during the plating growth on the seed layer 310 of the inner surface of the via hole.

Meanwhile, in a method of manufacturing the coil 300 by using the partition wall 250, as in the present disclosure, an opening pattern may first be formed in an insulator and then be used as the guide for the plating, and a shape of a coil conductor may thus be easily controlled unlike in a conventional anisotropic plating method. That is, each of the first and second coil portions 311 and 312 may have a flat surface in contact with the partition wall 250. Here, a term “flat” conceptually includes “substantially flat” as well as “completely flat”. That is, it is considered that the wall surface of the opening pattern may have a certain roughness by a photolithography method. A plating method is not particularly limited, may use electroplating, electroless plating, or the like, and is not limited thereto.

Next, the partition wall 250 may be removed after forming the first and second coil portions 311 and 312 and the via 320. The partition wall 250 may be removed using a known stripper or the like. Here, after removing the partition wall 250, the seed layer 310 may be etched to form a pattern.

Next, a through-hole TH passing through a support member 200 may be formed using a trimming process. The through-hole TH may be formed using a mechanical drill and/or a laser drill.

Next, the insulating film IF may be formed to integrally cover the support member 200 and the coil 300. The insulating film IF may be coated by chemical vapor deposition (CVD) or the like.

The coil component 1000, 2000, 3000, 4000, or 5000 having the tapered via 320 formed according to the process of this exemplary embodiment may have a lower risk of the void defect occurring in the via 320.

In comparison, referring to FIG. 10, the via hole may be processed in the upper and lower surfaces of the support member 200, and the void defect may thus finally occur in the via 320 in a coil component including an hourglass-shaped via 320 having the smallest diameter at the innermost side of the support member 200.

That is, the via 320 may be formed by performing the plating in the hourglass-shaped via hole in a first operation of FIG. 10. In this case, the plating growth may not be smooth in the innermost region of the support member 200, which has the smallest diameter, which may increase the possibility of the occurrence of the void defect, and the void occurring here may remain as it is in a final coil component.

It is possible to prevent the void defect from occurring in the coil component as shown in FIG. 10 described above when the ratio VD_{U}/VD_{L} of the diameter VD_{U} of the upper surface of the via 320 to the diameter VD_{L} of the lower surface of the via 320 is set to 1.06 or more and 1.64 or less like in the coil component 1000, 2000, 3000, 4000, or 5000 according to this exemplary embodiment.

As set forth above, according to an aspect of the present disclosure, it is possible to provide the coil component with the lower void defects occurring in the via hole during the plating process when forming the via passing through the support member.

According to another aspect of the present disclosure, it is possible to implement the thin coil component by the support member made thin.

According to another aspect of the present disclosure, it is possible to increase the production efficiency of the coil component by reducing the process operations of forming the via hole.

While the exemplary embodiments have been shown and described above, it will be apparent to those skilled in the art that modifications and variations could be made without departing from the scope of the present disclosure as defined by the appended claims.

What is claimed is:

1. A coil component comprising:
a body having a first surface and a second surface opposing each other in a first direction;
a support member disposed in the body, and having one surface and the other surface opposing each other;
a coil including:
first and second coil portions disposed on the one surface and the other surface of the support member and having at least one turn, respectively, and
a via passing through the support member to connect the first and second coil portions to each other; and
first and second external electrodes respectively disposed on the first and second surfaces of the body and connected to the coil,
wherein the via includes an upper surface in contact with the first coil portion and a lower surface in contact with the second coil portion, and
a ratio VD_{U}/VD_{L} of a diameter VD_{U} of the upper surface to a diameter VD_{L} of the lower surface is 1.06 or more and 1.64 or less.

2. The coil component of claim 1, wherein the via has a smaller diameter closer to the other surface of the support member.

3. The coil component of claim 1, wherein a thickness of the support member is 5 μm or more.

4. The coil component of claim 3, wherein the thickness of the support member is 10 μm or more and 45 μm or less.

5. The coil component of claim 1, wherein the via includes a seed layer.

6. The coil component of claim 5, wherein the support member includes a via hole in which the via is disposed, and at least a portion of the seed layer is disposed along an inner surface of the via hole.

7. The coil component of claim 6, wherein the inner surface of the via hole is inclined at an acute angle with respect to the other surface of the support member.

8. The coil component of claim 6, wherein the seed layer passes through the via hole.

9. The coil component of claim 8, wherein the seed layer is integrally disposed along the one surface of the support member, the inner surface of the via hole, and the other surface of the support member.

10. The coil component of claim 1, wherein the via connects an innermost turn end of the first coil portion and an innermost turn end of the second coil portion to each other.

11. The coil component of claim 1, wherein an aspect ratio of each turn of the first and second coil portions is 4.5 or more.

12. The coil component of claim 11, wherein the aspect ratio of each turn of the first and second coil portions is 6 or more.

13. The coil component of claim 1, wherein the coil further includes a first lead portion extending from an outermost turn of the first coil portion to the first surface, and a second lead portion extending from an outermost turn of the second coil portion to the second surface.

14. The coil component of claim 11, wherein the body further includes a third surface and a fourth surface opposing each other in a second direction perpendicular to the first direction, and
in a cross-section of the coil component passing through a center of the body and perpendicular to the first direction, a ratio Tc/LWc of a thickness Tc of each turn of the first and second coil portions in the second direction to a line width LWc of each turn of the first and second coil portions is 4.5 or more.

15. The coil component of claim 14, wherein the ratio Tc/LWc is 6 or more.

16. The coil component of claim 5, further comprising an insulating film integrally covering the support member and the coil,
wherein at least a portion of the seed layer is in contact with the insulating film.

17. The coil component of claim 1, wherein the body further includes a third surface and a fourth surface opposing each other in a second direction perpendicular to the first direction, and each of the first and second external electrodes at least partially extends to the third surface.

18. The coil component of claim 17, wherein the body further includes a fifth surface and a sixth surface opposing each other in a third direction perpendicular to the first and second directions, and
each of the first and second external electrodes at least partially extends to the fourth to sixth surfaces of the body.

19. The coil component of claim 1, wherein each of the first and second external electrodes includes at least one of palladium (Pd), silver (Ag), platinum (Pt), and gold (Au).

20. A coil component comprising:
a body having a first surface and a second surface opposing each other in a first direction;
a support member disposed in the body, and having one surface and the other surface opposing each other;
a coil including:
first and second coil portions disposed on the one surface and the other surface of the support member and having at least one turn, respectively, and
a via passing through the support member to connect the first and second coil portions to each other; and
first and second external electrodes respectively disposed on the first and second surfaces of the body and connected to the coil,
wherein the via includes an upper surface in contact with the first coil portion and a lower surface in contact with the second coil portion,
a ratio VD_{U}/VD_{L} of a diameter VD_{U} of the upper surface to a diameter VD_{L} of the lower surface is 1.06 or more and 1.64 or less, and
the diameter VD_{U} of the upper surface is greater than a line width of each of the at least one turn of the first and second coil portions.

21. The coil component of claim 20, wherein the via connects an innermost turn end of the first coil portion and an innermost turn end of the second coil portion to each other.

22. The coil component of claim 20, wherein an aspect ratio of each of the at least one turn of the first and second coil portions is 4.5 or more.

23. The coil component of claim 22, wherein the aspect ratio of each of the at least one turn of the first and second coil portions is 6 or more.
